(19) United States
(12) Patent Application Publication
(10) Pub. No.: US 2017/0017382 A1
(43) Pub. Date: Jan. 19, 2017

(54) SYSTEM AND METHOD FOR INTERACTION BETWEEN TOUCH POINTS ON A GRAPHICAL DISPLAY

(71) Applicant: Cinematique LLC, New York, NY (US)

(72) Inventors: Brian Tobin, Brooklyn, NY (US); Randy Ross, New York, NY (US); Kyle Heller, West Hollywood, CA (US)

(21) Appl. No.: 14/800,300

(22) Filed: Jul. 15, 2015

(51) Int. Cl. G06F 3/0484; G06F 3/0482; G06F 3/0481; G06F 3/041; G06F 3/0488

(52) U.S. Cl. CPC G06F 3/04847; G06F 3/041; G06F 3/0488; G06F 3/04817; G06F 3/0482

(57) ABSTRACT

Embodiments of the present invention described herein generally relate to systems, methods and computer program products for tracking and reacting to touch events that a user generates when viewing a video. In particular, the embodiments of the invention relate to systems, methods and computer program products for defining objects that enter and leave a video scene, as well as move within the video scene as a function of time. Embodiments of the invention further relate to systems, methods and computer program products for tracking and reacting to users who generate events through the selection of objects while viewing the video scene, which can be in the form of a video stream or file, as well as reacting to or further processing such events.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention described herein generally relates to systems, methods and computer program products for tracking and reacting to touch events that a user generates when viewing a video. In particular, the invention relates to systems, methods and computer program products for defining objects that enter and leave a video scene, as well as move within the video scene as a function of time. The invention further relates to systems, methods and computer program products for tracking and reacting to users who generate events through the selection of objects while viewing the video scene, which can be in the form of a video stream or file, as well as reacting to or further processing such events.

### DESCRIPTION OF THE RELATED ART

Using currently known systems and methods, the provision of digital services to monitor the tracking and placement of items in a video scene is a complex and laborious task, both computationally and in the manpower necessary to create instances of such services. A video scene, as used herein and throughout the present specification, refers to a series of video frames that a video player displays to a user in rapid sequence to depict particular sequence of action(s), such as a sailor walking across the deck of a boat, a model walking down a catwalk, etc.

Such systems as are known to those of skill in the art primarily rely on the use of HTML code to define interactive spaces or elements that are overlaid on top of a video scene, e.g., through the use of HTML DIV elements. As items move within the scene, such as a person running through the scene, the browser must constantly reposition the HTML elements in response to such movement, in addition to setting up listeners on each HTML element to catch for and react to user selection events, such as a click within one of the elements. Another drawback to such systems is that all HTML elements that a browser overlays on top of the video scene must be preloaded prior to the playback of any video. Furthermore, the browser must render each such HTML element, unnecessarily causing consumption of finite computing resources. Additionally, such system must utilize a series of one or more timers, which a browser can implement in JavaScript, to control the presentation and removal of elements from the display space, causing further consumption of computing resources.

Therefore, novel systems and methods are needed monitor and track items in a video scene, as well as reached to the selection of such items, while minimizing the consumption of limited computing and network resources.

### SUMMARY OF THE INVENTION

Embodiments of the invention are directed towards systems, methods and computer program products for providing “touch enabled” video. Touch enabled video is a mechanism for providing immersive and interactive experiences whereby viewers, for example, can simply “touch” various items in a video in which he or she is interested to obtain additional information, navigate layers of interactivity, etc. This is in contrast with a web-based experience, in which images, text and video may comprise hyperlinks to other content or sources, but lack a true interactivity in which a user can simply touch on an object of interest in a video scene, which may be subsequently recorded and used to obtain additional information to provide to the viewer.

The term “touch” or “touch event”, as used herein, is directed towards, but not limited to, a mouse click, a tap, a gesture, or similar indication of user selection or interaction with a particular object within a video scene that a video stream displays. A touch enabled video may be associated with an object file that defines “touch objects” or simply, “objects,” which define items within the touch enabled video that may be touched by a viewer of the touch enabled video, even as the items move in 2D or 3D space. Viewers may learn about, share information regarding or purchase items associated with objects they have touched from an touch enabled video. This event-based interface provides developers with enhanced flexibility when designing interactivity to such video. Embodiments further implement lazy loading of objects, e.g., through an API that loads subsets of objects during playback to increase initial load time.

Separating video content, e.g., the video stream itself, from the associated objects provides for encapsulation with strict separation of concern. Accordingly, video content producers are free to focus on the production of robust video content and interactivity designers and marketers are free to focus on interactivity and object definitions within the video, as well as actions taken and further information provided in response to object selection by a user.

According to embodiments, objects move in 2D space as a function of time as the user views the video. This space is represented as a grid of 2D coordinates covering the display space of the video player. Accordingly, an operator or administrator may define objects as appearing or displaying at any point in the grid. Furthermore, because the grid is a grid of coordinates that covers the display space of the video play in which the video renders, the grid can scale to any sized player. An operator may also configure the grid to define coordinate spaces in which an object appears, thereby providing for a configurable grid resolution. Furthermore, as an operator discretely defines a giving object, a nearly infinite number of objects can register as appearing at a given coordinate at a given time.

According to one embodiment, the present invention comprises a method for tracking and reacting to touch events that a user generates when viewing a video. The method according to the present embodiment comprises receiving the video at a video player on a client device, the video player under the control of a processor at a client device, and processing object data by the processor at the client device to identify the presence and placement of one or more objects that corresponds to items in the video. The video player renders the video under the control of the processor and the client device receives touch coordinates and a time that correspond to a touch made by the user on an object that corresponds to an item in the video. The client device cross-references the touch coordinates with the object data and records a touch on the object where the touch coordinates and the time are successfully cross-referenced with the object data.

The method of the present embodiment may further comprise rendering a visual indication into the video when recording a touch, the visual indication displayed in conjunction with the item in the video. More specifically, rendering the visual indication can comprise displaying an icon in conjunction with the item as the item moves in the video as a function of time. When processing the object data, embodiments of the present invention comprise identifying one or more data items, a given data item related to an object that corresponds to an item in the video. More specifically, processing the object data according to certain embodiments comprises identifying an x-y coordinate for a given object at a given time, as well as identifying a plurality of x-y coordinates for the given object at a plurality of corresponding times. The plurality of times can be synchronized with the presence and placement of items in the video.

In addition to the foregoing, embodiments of the present invention cover non-transitory computer readable media comprising program code that, when executed by a programmable processor, causes the processor to execute a method for tracking and reacting to touch events that a user generates when viewing a video. Program code in accordance with one embodiment comprises program code for receiving the video at a video player on a client device, the video player under the control of the processor at the client device, and program code for processing object data by the processor at the client device to identify the presence and placement of one or more objects that correspond to items in the video. Additional program code is provided for rendering the video at the client device and receiving touch coordinates and a time that correspond to a touch made by the user on an object that corresponds to an item in the video. Program code, which can be executed locally or remotely, cross-references the touch coordinates with the object data and records a touch on the object where the touch coordinates and the time are successfully cross-referenced with the object data.

The program code in accordance with the present embodiment can further comprise program code for rendering a visual indication into the video when recording a touch, the visual indication displayed in conjunction with the item in the video. More specifically, the program code for rendering the visual indication can comprise program code for displaying an icon in conjunction with the item as the item moves in the video as a function of time. With regard to processing the object data, embodiments of the present invention comprise program code for identifying one or more data items, a given data item related to an object that corresponds to an item in the video. More specifically, the program code for processing the object data according to certain embodiments comprises program code for identifying an x-y coordinate for a given object at a given time, as well as program code for identifying a plurality of x-y coordinates for the given object at a plurality of corresponding times. Program code can further be provided for synchronizing the plurality of times with the presence and placement of items in the video.

Still other embodiments of the present invention are directed towards a system for tracking and reacting to touch events that a user generates when viewing a video. According to the present embodiment, the system comprises a video player executing on a client device under the control of a processor to render a video scene on the client device to the user and an object data store to maintain information regarding the presence and placement of one or more objects that corresponds to items in the video. The system in the present embodiment further comprises a touch engine operative to receive touch coordinates and a time that correspond to a touch made by the user on an object that corresponds to an item in the video, cross-reference the touch coordinates with the information from the object data store and record a touch on an object where the touch coordinates and the time are successfully cross-referenced with the information from the object data store. A touch data store maintains a record of a successful cross reference by the touch engine.

According to one embodiment of the present invention, the object data store comprises one or more data items, a given data item related to an object that corresponds to an item in the video. More specifically, a given data item can comprise an x-y coordinate for a given object at a given time, as well as a plurality of x-y coordinates for the given object at a plurality of corresponding times. In addition to the foregoing, a visual indication can be rendered into the video when recording a touch, the visual indication displayed in conjunction with the item in the video, which may comprise display of an icon in conjunction with the item as the item moves in the video as a function of time

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A presents a block diagram illustrating a system for tracking and reacting to touch events according to one embodiment of the present invention;

FIG. 1B presents a block diagram illustrating a system for tracking and reacting to touch events according to another embodiment of the present invention;

FIG. 2 presents a flow diagram illustrating an overall method for tracking and reacting to touch events according to one embodiment of the present invention;

FIG. 3A illustrates item position in a first screen from user interface for tracking and reacting to touch events according to one embodiment of the present invention;

FIG. 3B illustrates item position in a second screen from user interface for tracking and reacting to touch events according to one embodiment of the present invention;

FIG. 3C illustrates item position in a third screen from user interface for tracking and reacting to touch events according to one embodiment of the present invention;

FIG. 4 presents a flow diagram illustrating a method for operating a client device to track and react to touch events according to one embodiment of the present invention;

FIG. 5 presents a flow diagram illustrating a method for a client device to track and react to touch events according to another embodiment of the present invention;

FIG. 6 presents a flow diagram illustrating a method for operating a server to track and react to touch events according to one embodiment of the present invention;

FIG. 7 presents a flow diagram illustrating a method for operating a server to track and react to touch events according to another embodiment of the present invention;

FIG. 8 presents a flow diagram illustrating a method for expanding distance thresholds to determine if a user touches an object in a video at a given time according to one embodiment of the present invention;

FIG. 9 presents a flow diagram illustrating a method for expanding timing thresholds to determine if a user touches an object in a video according to one embodiment of the present invention;

FIG. 10 presents a flow diagram illustrating a method for identifying and adding a new object to a video stream according to one embodiment of the present invention;

FIG. 11 presents a flow diagram illustrating a method for adding new objects to a video stream that is in the process of streaming to a client for playback according to one embodiment of the present invention; and

FIG. 12 presents a flow diagram illustrating a method for dynamically updating objects in a video that is streaming to one or more clients for playback according to one embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. Those of skill in the art understand that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Embodiments of the present invention provide for interactive or touch enabled video through separation of object definitions from the video in which the object appears, which a server may transmit to a client device as a video stream or a video file. Such encapsulation allows for flexibility in designing interactivity for a video and allows for improved performance by separating the transmission of video data from object data. Accordingly, video transmission may begin with the server only sending a subset of the object data to the client device, thereby improving client performance by allowing the client to begin playback as opposed to waiting for receipt of all object data for the video. Such transmission schemes also maximize computing and network resources by limiting the unnecessary transmission of object data over the network between the server and client device

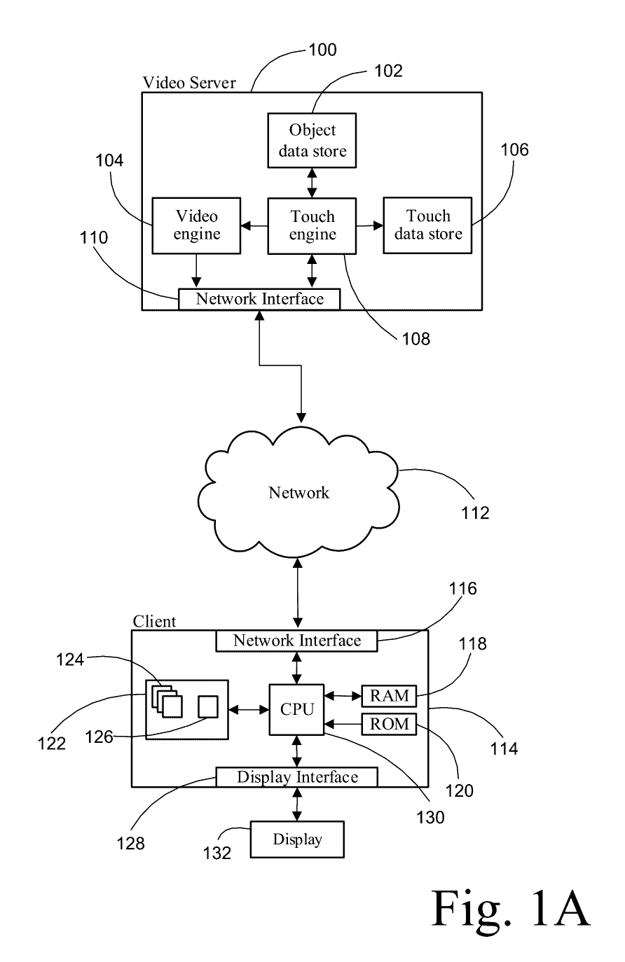

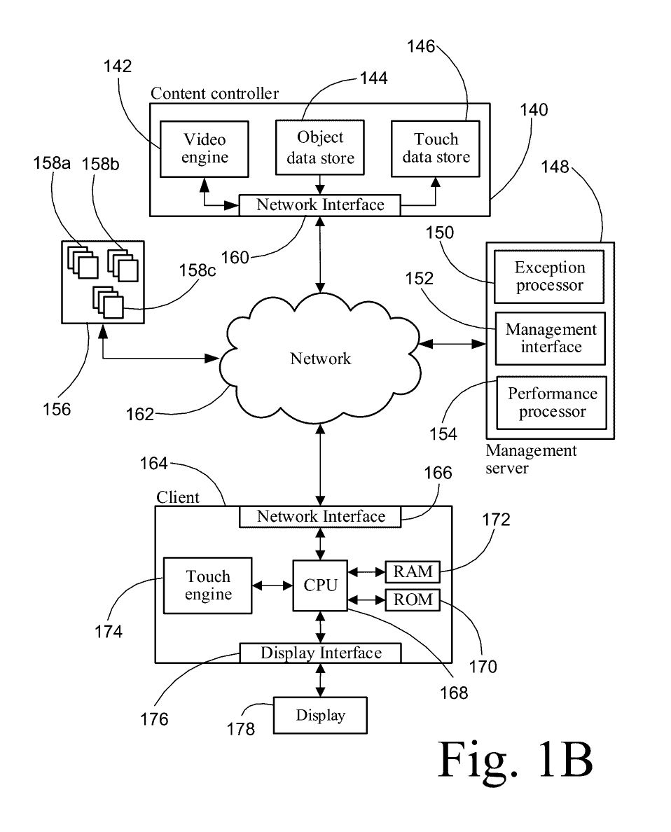

FIG. 1A presents a block diagram illustrating a system for tracking and reacting to touch events according to one embodiment of the present invention. The embodiment of FIG. 1A bifurcates the system into video server 100 and client 114 components, which are in communication over a data network, such as the Internet 112. The video server 100 in accordance with the present embodiment comprises components to serve touch enable video streams, as well as track and maintain indicia of user touches and touched objects contained within a given video stream, including an object data store 102, a video engine 104, a touch engine 108 and a touch data store 106. The network interface 110 serves as the point of interconnection between the video server 100 and the network 112, which can be made by way of physical network interface hardware, software, or combinations thereof.

A video engine 104 is operative to transmit video streams to one or more requesting client devices, e.g., client 114. The video engine 104 provides for playout of video files from video server 100, which may include the simultaneous playout of multiple video streams to multiple geographically distributed client devices 114 without any degradation of the video signal. The video server 100 can maintain local copies of video for the video engine 104 to stream or may maintain such video on remote volumes (not pictured) that the video engine 104 may access through communication over the network 112. The video engine 104 may utilize any number of coder-decoders (“codecs”) known by those of skill in the art to be suitable to streaming video including, but not limited to, H.264, VP6, Window Media, Sorenson Spark, DivX, Xvid, ProRes 422, etc. Once proper encoding is complete, the video engine 104 utilizes the network interface 110 to transmit the video stream over the network 112 to a requesting client.

The touch engine 108 works in concert with the video engine 104 and client 114 to allow the overall system to properly track and react to touch events that users are generating while viewing a given video stream. When a user requests a video stream for delivery by the video engine 104, the touch engine 108 receives a signal from the client device 114 providing an identifier for the video that the user is requesting. The indication that the touch engine 108 receives may be by way of a video id, index reference or identifier that uniquely identifies the videos that are available for streaming by the video engine 104 at the server 100.

The client device 114 provides the touch engine 108 with an identifier for the video that the user is requesting, causing the touch engine 108 to perform a lookup on the object data store 102. The object data store 102 is a data storage structure operative to maintain object data for one or more videos that the video server 100 is serving to requesting clients. As described above, each video that the video server 100 delivers to users by way of the video engine 104 comprises one or more objects that are available for selection as being of interest to the user. The object data store 102 maintains information identifying objects in a given video, as well as time and space information, which the object data store 102 can maintain on a per-video basis, a per-object basis or any other organizational scheme that allows for the touch engine 108 to identify objects that are contained in a given video.

Objects present in a video a specific point in time, may move through the video and then typically wipe from the display, e.g., move off screen. More specifically, an object may appear in a video at a specific point in time at a specific x-y location in the video, modify its placement, e.g., x-y location, in the video as a function of time (such as a model walking along a catwalk), and disappear from the video a specific point in time. For example, in a video that concerns women's cardigan sweaters, a woman wearing a sweater can be coded as an object making an initial appearance in the video at time thirty (30) seconds at a specific x-y coordinate and moving in space as a function of time. According to one embodiment, the object data store 102 maintains a series of time-coordinate pairs that track the object in 2D space over a certain period for a given video, which in accordance with certain embodiments, the object data store makes available to clients viewing the video.

The object data store 102 maintains time and location data for objects appearing in videos that the video server 100 is serving to clients. Information regarding a specific object that the object data store 102 maintains can include, but is not limited to, one or more videos with which the object is associated, the point in time in the video in which the object appears, the x-y coordinates for the object at the appearance time, the point in time in the video in which the object disappears and the x-y coordinates for the object at the disappearance time. Advantageously, the object data store 102 further maintains x-y coordinates for the object for time increments starting with the appearance time and ending with the disappearance time. Furthermore, in addition to specific x-y coordinates for an object, a threshold or distance around a specific set of x-y coordinates may form a part of the data comprising or defining an object.

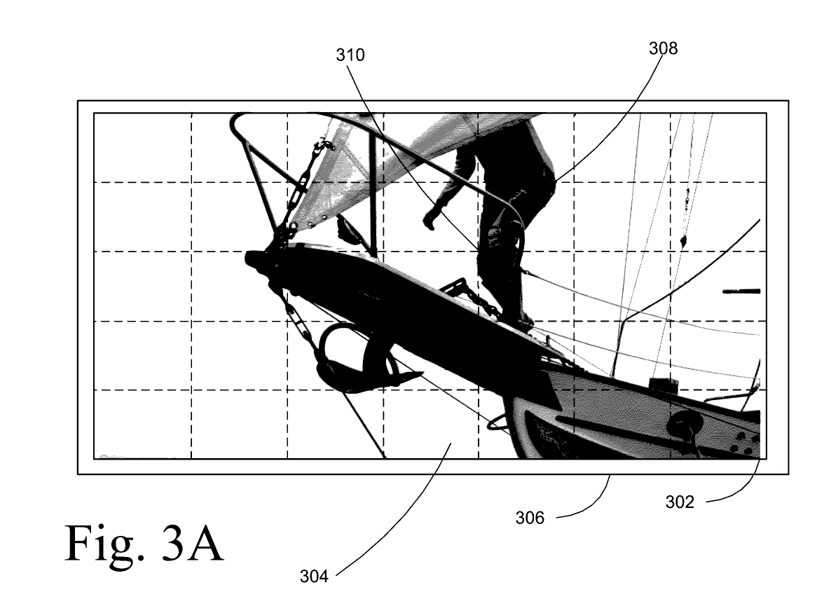

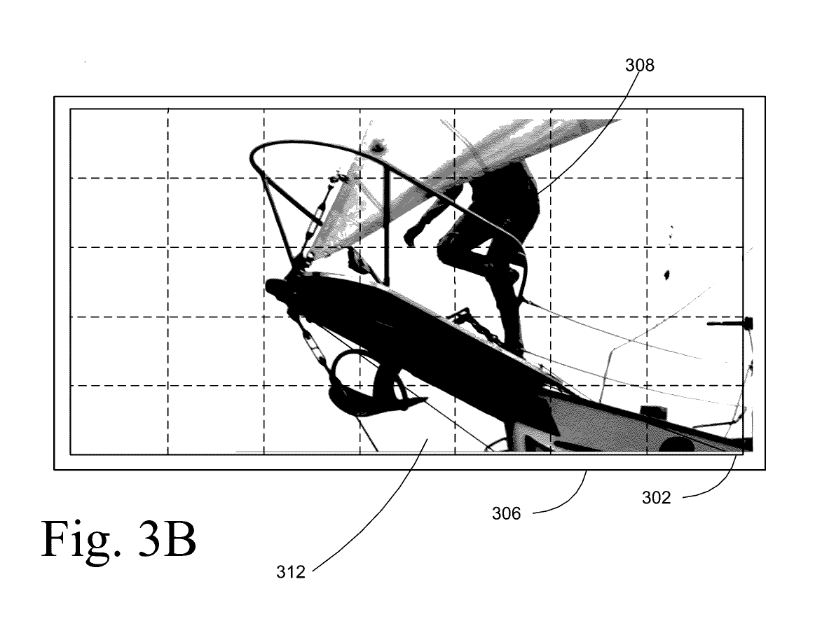

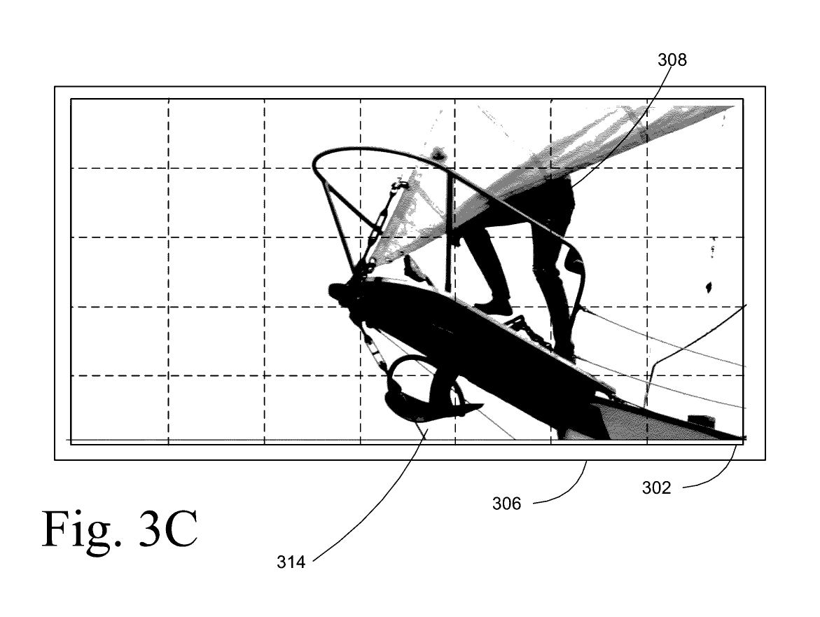

Alternatively, or in conjunction with the foregoing, the object data store 102 can store grid sector coordinates for an object at a given time point in a given video. As described herein and illustrated with respect to the exemplary interfaces of FIGS. 3A, 3B and 3C, the display area of the video player can be broken into a grid of x-y coordinates, such that a grid is formed over the display area of the video player. The grid is not visualized or rendered by the video player, but rather is a programmatic construct that breaks the display area of the video player into a number of sectors or coordinate spaces, e.g., a series of square regions that identify the display area. Accordingly, an object can be placed in a video at a specific point in time at a specific grid sector in the video, modify its placement, e.g., grid sector location, in the video as a function of time (such as a model walking along a catwalk), and disappear from the video a specific grid sector and point in time. An object may simultaneously reside in multiple grid sectors and grid sector size may be set on a per video basis (the grid can scale to any sized player or video), thereby providing varying or configurable grid resolution.

The object data store 102 can take the form of any suitable repository for a set of data objects, which according to one embodiment is a relational database that uses classes defined in a database schema for use in modeling such data object. Embodiments of the object data store 102 may also take the form of NoSQL or other types of “big data” stores, which provide mechanisms for data storage and retrieval not modeled on tabular relations, thereby providing simplicity of design, horizontal scaling and finer availability control. Those of skill in the art recognize that the data store is a broad, general concept that includes not only repositories such as databases, but also simpler structures such as flat files and character-delimited structures, and that any such data store may be utilized in providing persistent storage and structure for such object data.

The touch engine 108 receives a signal from the client device 114 providing an identifier for the video that the user is requesting, causing the touch engine 108 to retrieve a set of objects corresponding to the video from the object data store 102. As indicated above, the object data store 102 may organize objects corresponding to a particular video in a discrete file, causing the touch engine 108 to retrieve the file for processing. Alternatively, or in conjunction with the foregoing, the touch engine 108 may query the object data store 102 to identify objects that correspond to or are associated with the video that the user is requesting. In response, the object data store 102 may return to the touch engine 108 a set of information regarding objects that are responsive to the query. The touch engine 108 can load these data into memory and process incoming touch information from a given user on the basis thereof. Additional details with regard to processing of incoming touch information and received object data by the touch engine is provided herein.

In addition to the above-described components, which may be implemented in various combinations of hardware and software, the video sever 100 comprises a network interface 112 over which the video sever 100 communicates with one or more client device 114. The network interface 110 may provide physical connectivity to the network for the server, which may also comprise a wireless link for the physical layer, and may assist the video server 100 in managing the transmission of data to and from the network 112, e.g., ACK transmission, retransmission requests, etc. The network may be any network suitable for transmission of video data (and object data according to some embodiments) from the server to one or more client device 114. The network is preferably a wide area network such as the Internet.

The video server 100 utilizes the network interface 110 to transmit data over the network 1112 to one or more requesting client devices 114. According to the embodiment of FIG. 1A, an exemplary client device comprises a central processing unit 130 (“processor”) in communication with RAM 118, which provides transient storage for data, and ROM 120, which provides for persistent storage of a limited set of program code instructions. A client device 114 typically uses ROM for permanent or semi-permanent storage of startup routines or for resources that used throughout the operating system of the client device, e.g., MACINTOSH® Toolbox, or applications running thereon.

The client device 114 further comprises a persistent storage device 122, such as a hard disk drive or solid-state storage device. The persistent storage device 122 provides for storage of application program and data files at the client device 114, such as a video player application 126, as well as video and object data files 124, one or more of which may correspond to or be associated with the video files 126. In addition, a network interface 116 may provide physical connectivity to the network for the client device 114, which may also comprise a wireless link for the physical layer, and may assist the client device 114 in managing the transmission of data to and from the network 112, e.g., ACK transmission, retransmission requests, etc. Finally, exemplary client devices 114 comprise a display interface 128 and display device 132 that allows the user to interact with user interfaces that the client device 114 presents, and may further be integrated with an input device where the display comprises a touchscreen.

Claimed subject matter covers a wide range of potential variations in client devices. For example, a web-enabled client device 114, which may include one or more physical or virtual keyboards, mass storage, one or more accelerometers, one or more gyroscopes, global positioning system (“GPS”) or other location identifying type capability, or a display with a high degree of functionality, such as a touch-sensitive color 2D or 3D display. A client device 114 may also include or execute an application to communicate content, such as, for example, textual content, multimedia content, or the like. A client device 114 may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities in client devices 114 that connect to the video sever 100.

A client device 114 may also include or execute a variety of operating systems, including a personal computer operating system, such as a Windows, Mac OS or Linux, or a mobile operating system, such as iOS, Android, or Windows Mobile, or the like. In addition, a client device 114 may comprise or may execute a variety of possible applications, such as a client software application enabling communication with other devices, such as communicating one or more messages, such as via email, short message service (“SMS”), or multimedia message service (“MMS”).

A client device may use the network to initiate communication with one or more social networks, including, for example, Facebook, LinkedIn, Twitter, Flickr, or Google+, to provide only a few possible examples. The term “social network” refers generally to a network of individuals, such as acquaintances, friends, family, colleagues, or co-workers, coupled via a communications network or via a variety of sub-networks. Potentially, users may for additional subsequent relationships because of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds.

As described above, the video engine 104 is operative to transmit video streams to one or more requesting client devices 114. According to one embodiment, a user navigates through use of a client device 114 to a web page that a web server (not pictured) hosts for delivery to the user upon request. The web page may comprise HTML or similar markup code that, when rendered by a browser, presents a catalog or listing of motion touch enabled video to the client device 114. Selection of a given video initiates a communication session between the client device 114 the video server 100 and causes transmission to the server of information identifying the video that the user selects.

The touch engine 108 receives the request and passes the information identifying the video to the video engine 104. The video engine 104 receives the identifying information and attempts to locate the video file, which may be stored on a local or remote storage device (not pictured). The video engine 104 enters a wait state one it locates the file and conducts initialization in preparation of streaming the video the user is requesting to his or her client device 114. While the video engine 104 initializes, the touch engine 108 queries the object data store 102 to retrieve information regarding one or more objects associated with the video the user is requesting.

As the video engine 104 begins to stream the video to the client device 114 over the network 112, a video player application program executing at the client 114 on the CPU begins rendering the video stream as a series of images on the display device 132, which may further comprise rending audio by the client device 114. The video player application 126 executing at the client device 114 renders video data on the display 132 as it receives the video stream from the video engine 104.

As the user watches the video, he or she may interact with the video by issuing touches on the video. When the display 132 comprises an integrated touch sensor, the user may literally touch on items of interest as the video stream displays such items. When the client device 114 utilizes other input devices, such as a mouse, pen, stylus, etc., the user utilizes such input devices to displace a cursor over and select an item of interest as the video stream displays such items. Such events are considered touches for purposes of the present invention. The user interacts with the video as the video application 126 renders such data on the display 132, and program code executing by the CPU 130 at the client device generates touches (also referred to as touch events) for transmission over the network 112 to the touch engine 108. An exemplary touch event includes, but is not limited to, the x-y coordinates in the video player where the touch occurred and the elapsed time from the start of the video when the touch occurred.

As the touch engine 108 receives touch events over the network from the client device, the touch engine performs a look up or query on the object data received from the object data store. According to one embodiment, information comprising the touch event is used as the basis of a query on the data that the touch engine receives from the object data store. Alternatively, or in conjunction with the foregoing, the touch engine may use information comprising the touch event as the basis of a query of the object data store, which causes the object data store to return a result set comprising objects that are responsive to the query. Where the touch engine 104 determines that there is a match between the touch event and an object in the object data store, the touch engine 108 stores information regarding the touch event and corresponding object in a touch data store 106.

It should be noted by those of skill in the art, however, that not ever touch that the user issues has significance as indicating a desire to issue a touch on an object in the video stream. There are many instances however, where the user intends to issue a touch on an object in the video stream, but is either too slow (issue a touch before or after the object appears or disappears) or issues a touch that lacks accuracy (user timing is correct, but spatially not within the bounds of the object). The touch engine 108 writes information regarding these touches to the touch data store 106. As is explained in detail herein, such touches serve an important role in expanding spatial and temporal thresholds associated with object, e.g., the specific meets and bounds that define the area on the display where and time during which a touch event registers as a touch on an object.

As the server writes touches to the touch data store 106, other subsequent processes may interact with such data or use such data as input for further analysis. For example, by cross-referencing disparate users who have watched the same videos and touched the same objects, further advertisers, marketers and retailers can obtain further insight as to patterns and preferences. Such insights can also be driven by a degree of overlap or divergence between touches of groups of users, said touches on objects or clustered with other users on areas of a video that are not defined as objects. Furthermore, selecting objects in a video stream can direct the user to further information regarding the object that the user selects, e.g., controls to purchase the object.

For the duration of the video, the video engine 104 streams the video from the video server 100 over the network, with the video player 126 on the client device receiving the video stream for rendering on the display 132. Further, for the duration of the video, as the user interacts with the video and generates touch events, the touch engine 108 or other process at the video server 100 receives information regarding such events for matching against objects in the object data store, as well as storage in the touch data store. As FIG. 1A illustrates, most of the program code and hardware components for processing of events and other information are resident at the server, with the client device receiving and rendering video, as well as generating touch events.

FIG. 1B presents a block diagram illustrating a system for tracking and reacting to touch events according to an alternative embodiment of the present invention. According to the embodiment of FIG. 1B, most program code and hardware components for processing of events are located on the client device 164, with storage 140 and management 148 functions distributed across the network 162. Similar to the embodiment of FIG. 1A, the present embodiment maintains the video engine 142, object data store 144 and touch data store 146 remote from the client device 164 on a content controller 140. A remote data store 156, which may be a network accessible filesystem, provides persistent storage for several video files, e.g., video files 158a, 158b and 158c.

Also as with FIG. 1A, the present embodiment describes subject matter is intended to cover a wide range of potential variations in client devices 164 that are compatible with the present invention as described and claimed, but places hardware and runs program code comprising the touch engine 174 on the CPU 168 of the client device 164. Network interfaces 160 and 164, CPU 168, ROM 170, RAM 172, display interface 176 and display 178 all comprise hardware and software operating as described herein. With regard to the control controller 140, the video engine 142, object data store 144 and touch data store 146 also all comprise hardware and software operating as described herein.

FIG. 1B illustrates a management server 148 operating remote from the content controller 140 and client device 164. Although not pictured, those of skill in the art recognize that the management server 148 and content controller 140 (as well as video server from FIG. 1A) in addition to specialized hardware components, comprise standard hardware components such as processors, memory, storage, etc. The management interface 152 comprises program code that instructs the management server to execute one or more routines for management of the overall system. For example, management includes, but is not limited to, managing client accounts, uploading video, defining objects for various videos, etc.

In addition to the management interface 152, the management server implements and exception processor 150 and a performance processor 154, each of which comprises various combinations of task specific hardware and software. The exception processor 150 is operative to manage touches in the touch data store that do not necessarily correspond with an object in a given video. For example, and not by way of limitation, assume a video comprises a 30 second scene of a model on catwalk wearing a fur coat and holding a leather handbag, but the only object in the video is the handbag. Further assume that a number of users, wishing to express an interest in the fur coat, click on the fur coat. The touch engine 174 receives information regarding such touches for storage in the touch data store 146. As is described herein, the exception processor comprises program code that when executed by the processor of the management server causes the recognition of a potential new object based on a cluster of touches on the fur coat.

The performance processor 154 comprises program code that causes the monitoring, logging and reporting of a number of performance details. According to one embodiment, the performance processor 154 presents such performance details through a user interface that the management interface 152 provides. The performance processor 154 may log transmission speeds between the content controller 140 and various client devices 164 in communication through the network 162, including latency, delay and jitter that client devices are experiencing, transmission bandwidth utilized, storage space utilized for video 156, object 144 and touch 146 data storage, etc.

As the touch engine 174 receives touch events at the client device 164, the touch engine 174 performs a look up or query on the object data that it can receive from the object data store 144. According to one embodiment, information comprising the touch event is used as the basis of a query on the data that the touch engine 174 receives from the object data store 144. Alternatively, or in conjunction with the foregoing, the touch engine 174 may use information comprising the touch event as the basis of a query of the object data store 144, which causes the object data store to return a result set comprising objects that are responsive to the query. Where the touch engine 174 determines that there is a match between the touch event and an object in the object data store 144, the touch engine 174 stores information regarding the touch event and corresponding object in a touch data store 146. As with other embodiments, the touch engine 174 also writes touches to the touch data store 146 that are not matches with an object from the object data store 144 as such data is useful for expansion analysis and processing that the exception processor 150 can execute.

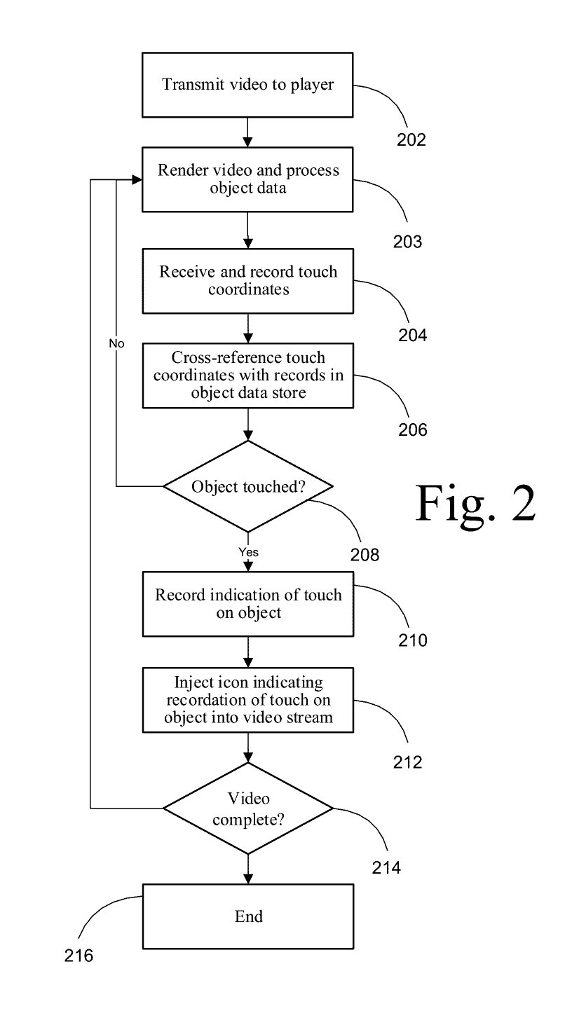

FIG. 2 presents an overall high-level flow diagram illustrating program code instructing a processor to execute a method for tracking and reacting to touch events according to one embodiment of the invention. According to the embodiment of FIG. 2, program flow begins with the processor executing instructions to transmit video to the player for rendering on a display device and object data, step 202, the display device being in communication with the client device on which the program code is executing. In accordance with various embodiments of the invention, the client device may receive the video and object data as a data stream that the client device receives from a streaming video server, rendering the video and processing object data as the client device receives such information. Alternatively, or in conjunction with the foregoing, the client device can receive video data files and object data files from a server, which the client device stores locally for playback and processing on the client device.

As the client device renders video and processes object data, the processor on the client device under instructions contained in executing program code is operative to begin display of the video that it is rendering on a display device, step 203. As the processor at the client device renders video on the display device, the processor also examines the object data to determine the presence of objects in the video scene that the processor is rendering. For example, at a given time, t, the processor renders the video data at time t in conjunction with examining the object file to determine if the object file indicates the presence of an object in the video scene at time t. As described herein above, the object file comprises instruction that inform the processor as to the presence of an object in a video scene. According to embodiments of the invention, the object file can comprise various data points including, but not limited to, a time when the object appears in the video scene, coordinates for the object when it appears in the video scene, additional entries as to the spatial displacement of the object in the video scene as the object moves as a function of time, and time and coordinates for when the object leaves the video scene.

The user, using an input device in communication with the client device, issues commands to the video player indicating interest in items that the processor is rendering for presentation on the display device, which the processor receives and records, step 204. As described above, those of skill in the art recognize that the user can utilize any number of input devices to issue commands to the video player running on the client device including, but not limited to, a mouse, pen, stylus, resistive touch screen, capacitive touch screen, etc. According to embodiments in which the input device is a user touch in conjunction with a capacitive touch screen, in step 204 the processor receives and records touch coordinates in response to a user touching on objects corresponding to items in the video scene that the processor is rendering for display in the video player application on the display device. As used herein and throughout the present detailed description of various embodiments of the invention, a “touch” generically indicates input from the user evidencing an intent to select an object corresponding to an item in the video scene that the processor renders in the video player as part of the video stream that the video player presents on the display device.

When receiving a touch from the user, program code that the processor is executing instructs the processor to cross-reference the touch coordinates with object data, step 206. As indicated above, a server can transmit object data to the client device for processing and use in the cross-reference of step 206. Alternatively, program code can instruct the processor to initiate communication with the server to access an object data store. According to this embodiment, the client device access the object data store, passing time and coordinate information for a touch that the client device receives from the user.

Whether the cross-reference of step 206 is conducted by processing object data locally at the client device or remotely at the server by accessing the object data store, a check is performed to determine if the user touched an object in the video scene, step 208. When receiving a touch from the user, there are many images in the video scene that are not objects and are therefore not necessarily of significance. Accordingly, a check determines if an object receives a touch from the user, step 208, as opposed to video not identified as an object. Where the user does not touch an object that the video player is displaying as part of the video scene, program flow returns to stop 203 and processor instructs the video player continues to render the video that the user requests. Where the cross-reference with object data indicates that the user has touched on an object in the video, steps 206 and 208, the processor records an indication of the user touch on the given object, step 210. Optionally, the processor can inject an icon or other visual representation that indicates recordation of the touch on an object corresponding to an item in the video scene that the processor renders in the video player as part of the video stream, step 212. According to alternative embodiments, the processor does not present a cue to indicate recordation of the touch, with the video player continuing to render video while receiving touches from the user.

As the processor continues to receive and process touches from the user, the processor performs a check to determine if playback of the video under observation by the user is complete, step 214. Where the check indicates that the video is not complete, or that the user has not terminated playback of the video, program flow returns to step 203 with the processor continuing to instruct the video player to render video on the display device, as well as receive and process touches from the user. Where playback of the video is complete, the process concludes, step 216.

FIGS. 3A, 3B and 3C illustrate transitions in a user interface for tracking and reacting to touch events according to another embodiment of the present invention. The interface of FIG. 3A presents a video player 302 rendering a video scene 304 on a display device 306. In the video scene 304, there are a number of items included as part of the scene, but the present example only defines one item 308 corresponding to an object. The object definition may comprise coordinates for the object at a first time t, which map to the grid 310. Those of skill in the art should note that the grid is shown for illustrative purposes only and does not form part of the user interface that the video player 302 renders on the display device 306.

According to the interface of FIG. 3B, the video player 302 renders a subsequent frame of the video scene 312 on the display device 306 at a subsequent time t+1. According to the interface of FIG. 3B, the item 308 corresponding to the object has moved or otherwise changed its displacement in the 2D space that the grid defines. Similarly, the interface of FIG. 3C illustrates the video player 302 rendering another subsequent frame of the video scene 314 on the display device at another subsequent time t+2. According to the interface of FIG. 3C, the item 308 corresponding to the object has again moved or otherwise changed its displacement in the 2D space that the grid defines.

As the interfaces of FIGS. 3A, 3B and 3C illustrate, an object moves through a video scene, in the present embodiment at 2D space, as a function of time. Accordingly, the x-y coordinates at which the object is located at a given time may change, with such changes or transitions for the object recorded in an object data store as coordinate-time pairs, such that the touch engine can determine the location of the object at a given time.

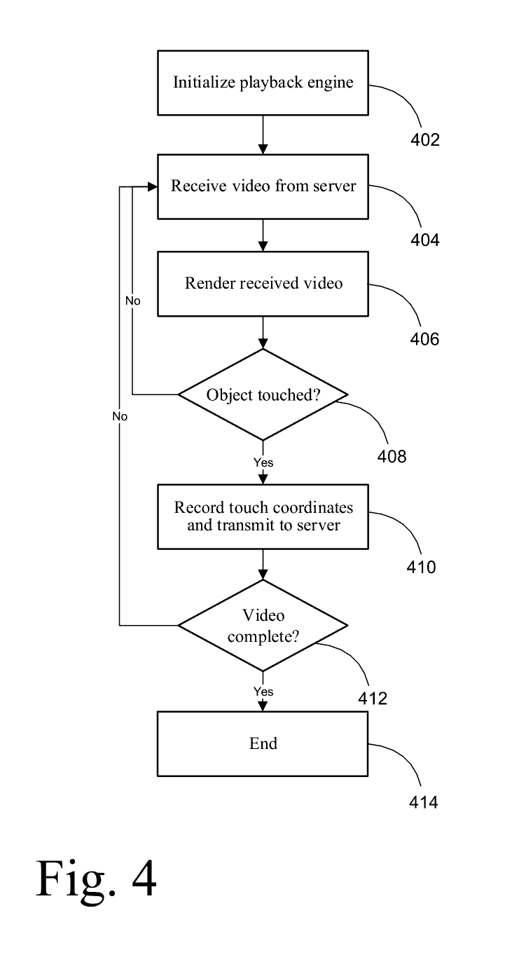

As described above, various embodiments of the invention implement a distribution architecture in which most business logic remains on the server. FIG. 4 presents a flow diagram illustrating program code instructing a processor to execute a method for operating a video player on a client device under such an architecture to track and react to touch events according to one embodiment of the present invention. According to the embodiment of FIG. 4, program code at the client device instructs the processor to initialize a playback engine residing at the client device, which may be part of a video player application that the processor can execute, step 402.

The processor at the client device initializes the video engine, step 402, which may include providing the video engine with a URL or other address to identify the location of video for playback, and beings receiving video for playback by the video player, step 404. According to various embodiments, the video player may receive the video as a stream from a server, may download the video as a complete file and begin rendering once download is complete, or various combinations thereof as are known to those of skill in the art.

Upon initialization, the video player connects to a video source that the initialization step can provide as part of the video player startup and begins to receive the video stream from the source server, step 404. As the video player receives video data, step 404, program code executing by the processor at the client device instructs the video player to render the video data on a display device. Accordingly, as the client device receives video data, the video player presents such data on the display device. Alternatively, or in conjunction with the foregoing, the client device can wait until it receives the video data in its entirety prior to commencing playback. Combinations of these various embodiments fall within the scope of the invention.

As the video player at the client device renders video on the display device for viewing by the user, the user may indicate interest in certain items that are rendering as part of the video scene by touching on objects corresponding to such items. For those embodiments in which the input device is a capacitive touch screen, the user may indicate a touch by touching the objects of interest in the video scene. Accordingly, the program code instructs the processor to perform a check during playback to determine if the user has issued a touch on an object in the video scene, step 408, as opposed to portions of the scene that are not identified as objects. Where the check indicates that the user is selecting portions of the video scene that are not identified as objects, step 408, program flow returns to step 404 in which the video player continues to render video data that it is receiving from the server. According to embodiments in which the client device receives the video file in its entirety, program flow can return to step 406 in which the video player continues to render the video data downloaded from the server.

Where the check indicates that the user is selecting portions of the video scene that are identified as objects, step 408, the touch coordinates are recorded for transmission to the server, step 410. According to one embodiment, the client device collects the touch coordinate for transmission to the server, although the raw input data can be provided directly to the server for formulation of the touch coordinates, as well as a determination that an object has received a touch from the user. Upon recording touch coordinates for transmission to the server, step 410, which the sever may perform on a periodic basis, a check is performed to determine if playback of the video is complete, step 412. Where the user is still viewing the video, e.g., playback is not complete, program flow returns to step 404 (or in certain embodiments to step 406) and the video player continues playback of the video under consideration by the user. If the check at step 412 evaluates to true, playback ends and the process concludes, step 414.

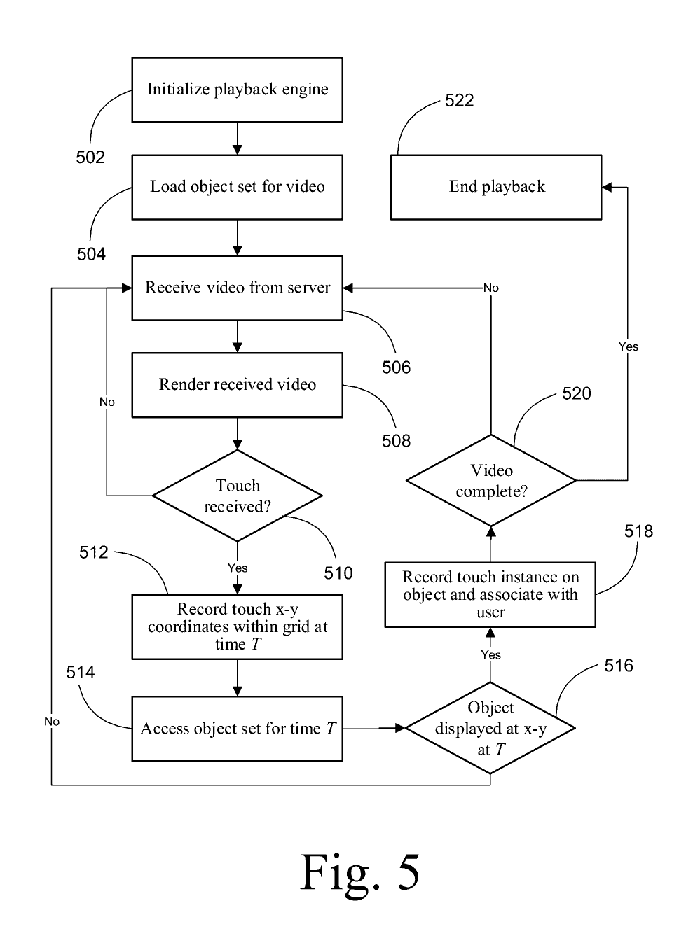

In addition to the program flow that FIG. 4 illustrates, FIG. 5 presents another embodiment of a flow diagram illustrating program code instructing a processor to execute a method for operating a client device under an architecture in which most business logic resides at the client device, thereby allowing the client to control tracking and reacting to touch events. As with other embodiments, program code executing by the processor at the client device initializes a playback engine on the client device, step 502, which may be a video player or similar software or hardware configured to render video that the client receives. According to the present embodiment, initialization comprises providing the video player with a URL or similar address from which to retrieve video for playback, but other mechanisms for identifying video for playback that are known to those of skill in the art may be utilized. In conjunction with initialization of the video player, the client device loads an object set for the video, step 504, which may comprise retrieving the object set in the form of a file from an object data store. Once the client device has the object set, the client has sufficient data to discern those touches from the user that intended to indicate a touch on an object in the video scene.

Upon initialization and obtaining the necessary object set, program code executing by the processor instructs the client device to begin receiving or retrieving video from the server that is hosting the video data, step 506. As described above, the client device may stream the video data from the server or may be operative to download the video data as a video data file for playback during or upon completion of the download. Regardless of the method by which the client device obtains the video data for playback on the display device in communication with the client device, the client device begins to render the video data once it receives a sufficient amount of data for playback, step 508.

During playback by the video player on the client device, hardware or software modules at the client device, which are in communication with the processor and under control of program code running thereon, are in communication with an input device at the client and listening for touches that the user is issuing through use of an input device, step 510. When such hardware or software modules receive an indication that the user is issuing a touch, the client device records the x-y coordinates (x-y-z coordinates in 3D interface systems) where the user places the touch in the grid, step 512, as well as the time (T) in the video at which time the user issued the touch. The processor receives the coordinates from the input device and reads the current time in the video from the video player although those of skill in the art recognize that equivalent sources are available for the retrieval of such information. According to the present embodiment, which other embodiments of the invention may implement, all touches that the user issues are recorded for processing and analysis, as opposed to only those touches on objects, which has utility in modifying the definition of existing objects as well as defining new objects.

Based on the coordinate and time information for a given touch, program code executing on the client device instructs the processor to access the object set for the video at time T, step 514, and performs a check to determine if an object exists at the time and coordinates that the client device receives, step 516. According to one embodiment, such data form the basis of a query or lookup that the client device executes against the object set. Where the check at step 516 evaluates to true, indicating that the user is selecting an object in the video scene, program code instructs the processor to record an indication that the user is issuing a touch on an object, step 518, which includes information associating the touch by the user and the object. For example, the processor may write data to a transient or persistent storage device indicating user information and the object in which the user is expressing interest, which may further comprise writing x-y and timing information for the touch to the transient or persistent storage device.

When accessing the object set for the video at time T and performing a check to determine if an object exists at the time and coordinates that the client device receives, step 516. The check evaluates to false where the video player is not displaying an object at the time the user issues a touch at the x-y coordinates that the processor receives from the input device, causing program flow to return to step 506 or 508, depending on whether the client device is streaming or downloading the video data. In any event, the client device performs a check on a periodic basis to determine if playback of the video is complete or the user has otherwise terminated playback, step 520. As with step 516, where the check at step 520 evaluates to false program flow returns to step 506 or 508, depending on whether the client device is streaming or downloading the video data. Where playback of the video is complete, program code executing at the processor instructs the video player to end playback, step 522.

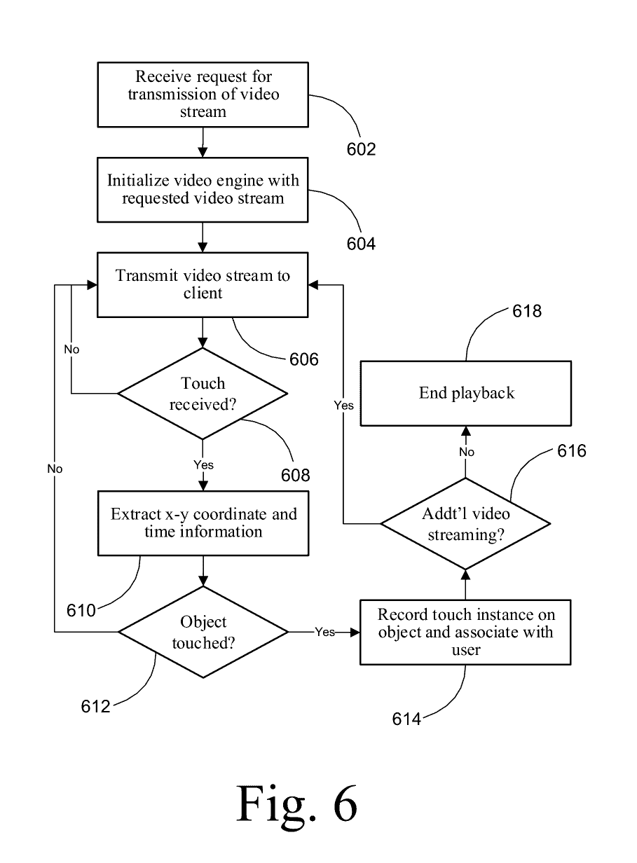

FIG. 6 presents a flow diagram illustrating program code instructing a processor to execute a method for operating a server to track and react to touch events according to one embodiment of the present invention. Although the embodiment of FIG. 6 illustrates server transmission of streaming video to the client device, those of skill in the art recognize that such processes are equally applicable for use in conjunction with downloaded video techniques. The process of FIG. 6 begins with the server receiving a request from a client device for transmission of a video stream, step 602. In response to the receipt of a request for a video stream, the server transmits information sufficient for initialization of a video engine with the requested video stream, step 604, which may comprise identifying a URL or address from which the video engine can retrieve the video data for streaming to the client device. Alternatively, the server prepares the video file for transmission to the requesting client device.

Subsequent to receipt of the video request from the client device, steps 602 and 604, the server begins transmission of the video stream to the requesting client device, step 606. As the server transmits the video stream to the requesting client device, program code at the server implements a sub-process to listen for the generation of events from the input device that is in communication with the client device. The server may capture events that the user is generating with the input device through use of hardware or software at the client device that forwards such events to the server. According to such embodiments, hardware or software at the client device forwards copies of such events to the server while allowing program code at the client device to otherwise handle such events in the normal course of operation, e.g., the operating system resident and executing at the client device.

As the server receives events from input device at the client device, the server performs a check to determine if the input indicates receipt of a touch, step 608, which is in contrast to other input events such as keyboard events. Where the check that the server performs indicates that the event is a touch, the server extracts X-Y coordinate information from the event, as well as time information regarding the current time in the video when the user generates the touch. According to embodiments of the invention, the server may query the video engine to determine the current time in the video when the user generates the touch. Those of skill in the art should note that according to the present embodiment the server is operative to record all touches that it receives from the client device, but may be configured to record just those touches that the server identifies as touches on objects.

Based on the information that the server extracts from the event that it receives from the client device, the server performs a check to determine if the event indicates the user is touching an object, step 612. The server can determine that the user is touching an object by accessing the object data store, performing a lookup of objects for the video under consideration, and then performing a subsequent lookup based on the coordinate and timing information from the event. As such, the server can determine if the user has touched on an object in the video scene as opposed to extraneous portions of the video or portions of the video that object set for the video does not identify as objects. Where the server determines that the user is touching an object, step 612, the server records an instance of the touch for the object and creates an association with the user for storage in a data store, step 614. Accordingly, the server may provide other hardware and software processes with historical information regarding what objects the user has touched in a given video.

In addition to sub-processes listing for events from the input device in communication with the client device to determine receipt of a touch, step 608, various combinations of hardware and software at the server implement a check for termination of the video stream, step 616. Ending playback of the currently playing video may occur when streaming of the video is complete or when the user affirmatively terminates the video, e.g., closes the player, loads a subsequent video, navigates to a new resource, etc. Where playback of the currently rending video does not terminate, step 616, the server continues to stream video to the client device, step 606, and listen for touches that the user is generating while viewing the video rendering at the client device, step 608, until a termination condition is met, step 616.

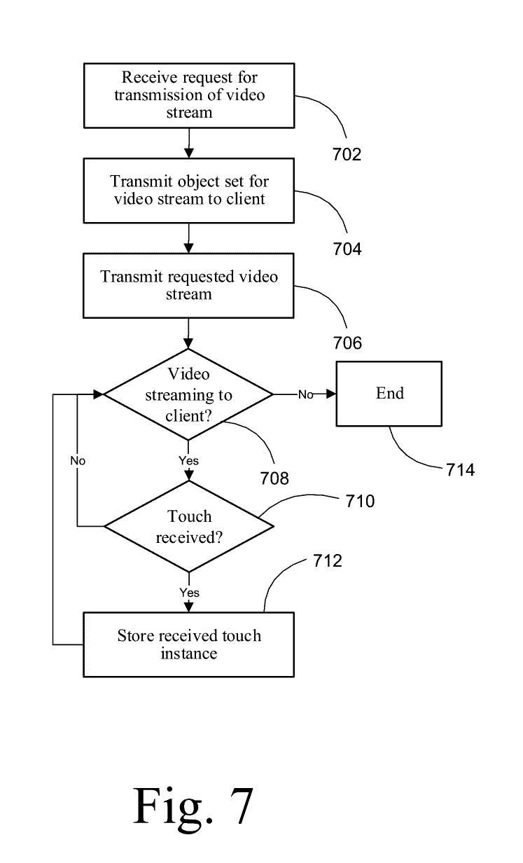

FIG. 7 presents a flow diagram illustrating program code instructing a processor to execute a method for operating a server to track and react to touch events according to another embodiment of the present invention. According to the embodiment of FIG. 7, the server is operating under an architecture in which most business logic resides at the client device, thereby allowing the client to control tracking and reacting to touch events. The process of FIG. 6 begins with the server receiving a request from a client device for transmission of a video stream, step 702. In response to the receipt of a request for a video stream, the server transmits information sufficient for initialization of a video player at the client device with the requested video stream, which may comprise identifying a URL or address from which the video engine can retrieve the video data for streaming to the client device. Alternatively, the server prepares the video file for transmission to the requesting client device.

In addition to preparing the video player at the client device for playback of the video stream that the user is requesting, the sever selects an object set for the video from its object data store for transmission to the requesting client device, step 704. According to one embodiment, the object data store maintains objects on a per-video basis and uses a unique identifier associated with the video that the user is requesting to identify object data for the video. As described above, the object data store is normalized insofar as identical objects in the object data store are de-duplicated and assigned to multiple videos, as opposed to maintaining object data for identical objects appearing in disparate videos.

The sever identifies data representing objects that appear in the video and packages the object data into an object data set, step 704, and begins transmission of the video stream to the user, step 704. At this point in the present embodiment, control passes to the client device for further processing, such as playback of the video using the video player at the client device, processing of user input, object touch determination, etc. The server performs a check to ensure that the video is rendering by the video player at the client device, step 708. The check at step 708 can be implemented using any number of inter-process communication techniques known to those of skill in the art that allow the client device to pass a signal, indication or message over the network to the sever indicating that the video is rendering. Exemplary techniques include, but are not limited to, SOAP, JSON-RPC, D-Bus, CORBA sockets, named pipes, etc.

The server also periodically checks for receipt of information from the client device indicating generation of a touch by the user, step 710, which includes data regarding the touch such as spatial coordinate information and time information indicating the time at which point the user generated the touch. According to embodiments of the invention, the server receives information regarding every touch on the video scene by the user, regardless of whether or not the touch is on an object. When utilizing high-latency or low-bandwidth networks, the client device may maximize network resources by only transmitting those touches that are on objects appearing in the video scene, which can be in accordance with instructions that the client device receives from the server or may be in response to the client device evaluating the current network state. Where a touch is not received, step 710, program flow returns to step 708 with the server again checking to determine if the video is still rendering on the client device, e.g., streaming to the user.

When the server receives information from the client device indicating generation of a touch by the user, step 710, the server writes or otherwise stores the data to a touch data store, step 712. The touch data store maintains such touch information on a per-user basis such that the server can identify the entire history of touches that a given user generates in a given video, as well as across videos. Program flow returns to step 708 with the server again checking to determine if the video is still rendering on the client device, e.g., streaming to the user. Where the check at step 708 evaluates to false, e.g., the video is no longer rendering on the client device, the process terminates, step 714.

As described in conjunction with the various embodiments of the invention, the client or server, depending on the specific embodiments deployed, determines if a user is touching an object on the basis of coordinates and time of the touch matching the time and coordinates of the object. For example, the client device identifies an object as part of a video scene at time thirty seconds (30 sec.) and at coordinates 100-150 (x-y). Where the client touches the video scene at the same time and coordinates, the system registers a touch by the user on the object. Situations occur, however, where the user is attempting to indicate a touch on a given object, but spatially misses touching the object in the video scene. Accordingly, present invention comprises embodiments that provide for processes spatial expansion of an object definition, e.g., the x-y points in the video scene that identify a given object.

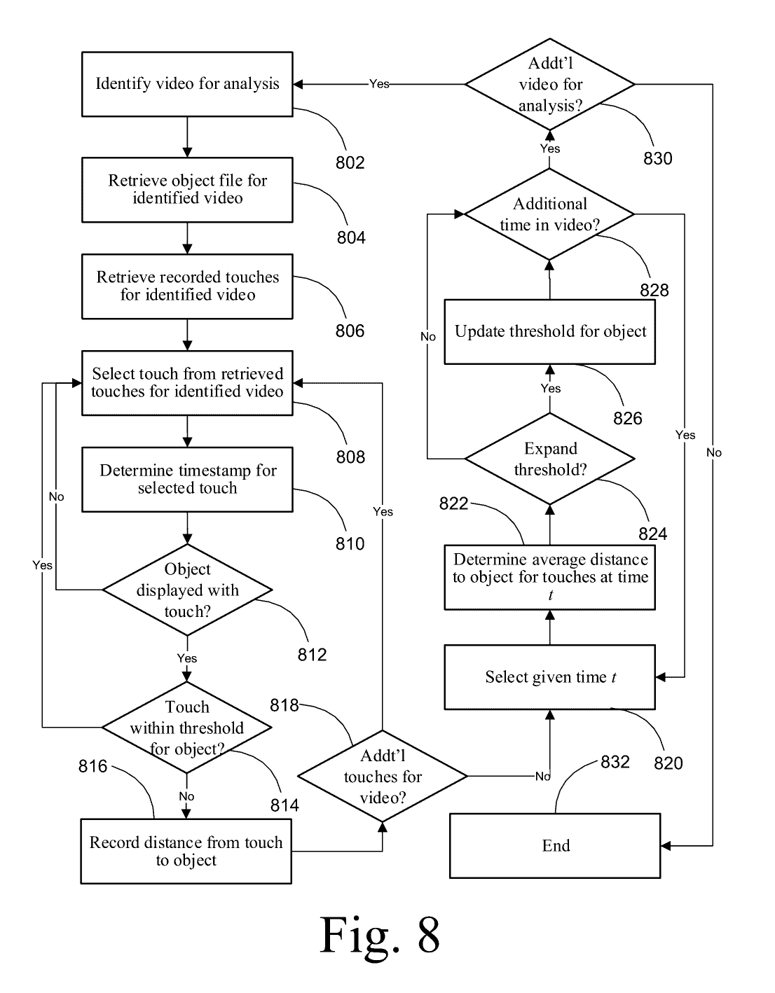

Building on this point, FIG. 8 presents a flow diagram illustrating program code instructing a processor to execute a method for expanding distance thresholds to determine if a user touches an object in a video at a given time according to one embodiment of the present invention. The embodiment that FIG. 8 illustrates is an off-line process that begins with the identification of a video for analysis, step 802. For the video under analysis, the system retrieves an object file or set of objects for the video that identifies the objects appearing in the video, step 804, and retrieves the historical touches that users have generated while rendering the video on client devices, step 806. The system may retrieve the object file or set of objects from an object data store and the recorded touches from a touch data store.

Once the system identifies the video, object and touches, processing of the recorded touches commences to identify touches in which a user intended to touch an object but otherwise spatially missed. The processing iteratively moves through touches that the system identifies, with the selection of information for a touch from the retrieved touches for the identified video, step 808. The system determines or otherwise identifies a timestamp for the touch, step 810, which may indicate the point at which the touch occurred as an offset from the start of the video.

Next, the system performs a check to determine if the video was displaying an object in conjunction with the touch, step 812. Where the client device did not identify an object as part of the video scene the video player was rendering when the user issued the touch, program flow returns to step 808 with the selection of information for a subsequent touch. Where the check at step 812 evaluates to true, the system performs a subsequent check to determine if the touch was within a threshold for the object, step 814, e.g., do the touch coordinates match the object coordinates at the time of the touch. A threshold may also comprise a given distance from a coordinate, a plurality of coordinates that identify the object, a circumference around a given coordinate or set of coordinates, etc. Those of skill in the art recognize that the method may perform an additional check subsequent to the execution of steps 812 and 814 to confirm that additional touch events exist for the video that require processing, e.g., step 818.

Where the touch falls within the threshold for the object, program flow returns to step 808 with the selection of information for a subsequent touch. Where the touch falls outside the threshold, meaning that the user intended to indicate a touch on the object but spatially missed the object, the system records the distance from the touch to the object, step 816. According to one embodiment, the system records the distance as the linear distance between the touch and the object. Upon processing of the information for the touch, the system performs a final check in the sub-process in which it makes a determination whether there are additional touches for the video that require processing, step 818. Where there are additional touches that require processing, program flow returns to step 808 with the selection of information for a subsequent touch.

The system concludes initial processing of information for touches in a given video, steps 808, 810, 812, 814, 816 and 818, and begins distance threshold expansion analysis to determine if the distance thresholds indicating a touch on an object require expansion. The system selects a given time, t, at which video player at the client device renders an item in a video scene that corresponds to an object, step 820. Based on the time t and the distances recorded at step 816, the system determines an average distance to the object for the touches occurring at time t, step 822, which the system provides as input to determine if it should increase the threshold for the object, step 824. According to one embodiment, the average distance passing a set maximum indicates to the system that it should increase the threshold for the object. When a user subsequently watches the video at time t and attempts to touch an object, the system registers the touch as a touch on the object if the touch is within the average distance from the coordinates that identify the object.

Where the check at step 824 evaluates to true, the system updates the threshold of the object, step 826, which according to one embodiment comprises the system increasing the threshold for the object to be equal to the average distance that the system generates in step 822. Regardless of whether the check as step 824 evaluates to true or false, program flow proceeds to the check at step 828 with the system determining if additional time remains in the video. Where additional time is remaining in the video, the system selects a next given time, t+x, at which video player at the client device renders an item in the video scene corresponding to an object, step 820. Where analysis of the video is complete, step 828, the system performs a check to determine if there are additional videos that require analysis, step 830, directing the system to either identify a next video for analysis, step 802, or conclude processing, step 832.

As described above, situations occur where the user is attempting to indicate a touch on a given object, but spatially misses touching the object in the video scene. A similar situation exists where the user is attempting to indicate a touch on a given object, but temporally misses touching the object in the video scene. Accordingly, present invention comprises embodiments that provide for temporal expansion of an object definition, e.g., the time window in the video scene that the system uses to identify a given object.

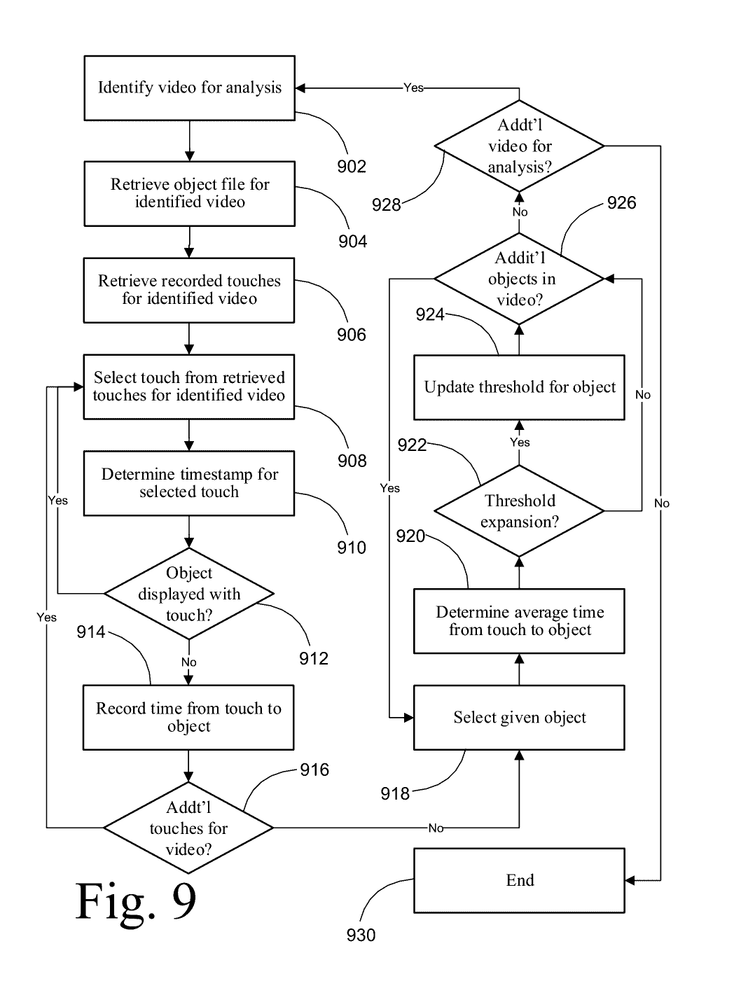

FIG. 9 presents a flow diagram illustrating program code instructing a processor to execute a method for expanding timing thresholds to determine if a user touches an object in a video according to one embodiment of the present invention. The embodiment that FIG. 9 illustrates is an off-line process that begins with the identification of a video for analysis, step 902. For the video under analysis, the system retrieves an object file or set of objects for the video that identifies the objects appearing in the video, step 904, and retrieves the historical touches that users have generated while rendering the video on client devices, step 906. The system may retrieve the object file or set of objects from an object data store and the recorded touches from a touch data store.

Once the system identifies the video, object and touches, processing of the recorded touches commences to identify touches in which a user intended to touch an object but otherwise temporally missed. The processing iteratively moves through touches that the system identifies, with the selection of information for a touch from the retrieved touches for the identified video, step 908. The system determines or otherwise identifies a timestamp for the touch, step 910, which may indicate the point at which the touch occurred as an offset from the start of the video.

The system next performs a check to determine if the video was displaying an object in conjunction with the touch, step 812. Where the client device did identify an object as part of the video scene the video player was rendering when the user issued the touch, program flow returns to step 908 with the selection of information for a subsequent touch. Where the check at step 912 evaluates to true, meaning that the user intended to register a touch on the object the system but temporally missed, the system records the time from when the client stopped rendering the object to the time when the user generated the touch, step 914. Alternatively, or in conjunction with the foregoing, the system may record the time from when the user generated the touch to when the client begins to render the item in the video scene corresponding to the object. The sub-routine ends with a check to determine if additional touches exist for the video that require processing, step 916. If the check evaluates to true, program flow returns to step 908 with the selection of information for a subsequent touch, otherwise processing proceeds.

The system concludes initial processing of information for touches in a given video, steps 908, 910, 912, 914 and 916, and begins temporal threshold expansion analysis to determine if the time thresholds indicating a touch on an object require expansion. The system selects a given object that the video player identifies as corresponding to an item displayed at the client device, step 918. Based on the object and the times recorded at step 914, the system determines if it should increase the time threshold for the object, step 824. According to one embodiment, the average time passing a set maximum indicates to the system that it should increase the threshold for the object. When a user subsequently watches the video and attempts to touch an object, the system registers the touch as a touch on the object if the touch is within the average time from the touch to the object disappearing or vice versa. For example, if the video player at the client renders the video scene identifying the object from time 20 seconds to 30 seconds in the video scene, and the average time from the object being removed from the scene to receipt of the touch is three (3) seconds, the system can record a touch as being on the object from time 17 seconds to time 33 seconds.

Where the check at step 922 evaluates to true, the system updates the threshold for the object, step 924, which according to one embodiment comprises the system increasing the threshold for the object to be equal to the average time that the system generates in step 920. Regardless of whether the check as step 922 evaluates to true or false, program flow proceeds to the check at step 926 with the system determining if additional object are present in the video. Where additional objects in the video require processing, the system selects a next object that the video player at the client device identifies as corresponding to an item displayed as part of the video, step 918. Where analysis of the video is complete, step 926, the system performs a check to determine if there are additional videos that require analysis, step 928, directing the system to either identify a next video for analysis, step 902, or conclude processing, step 930.

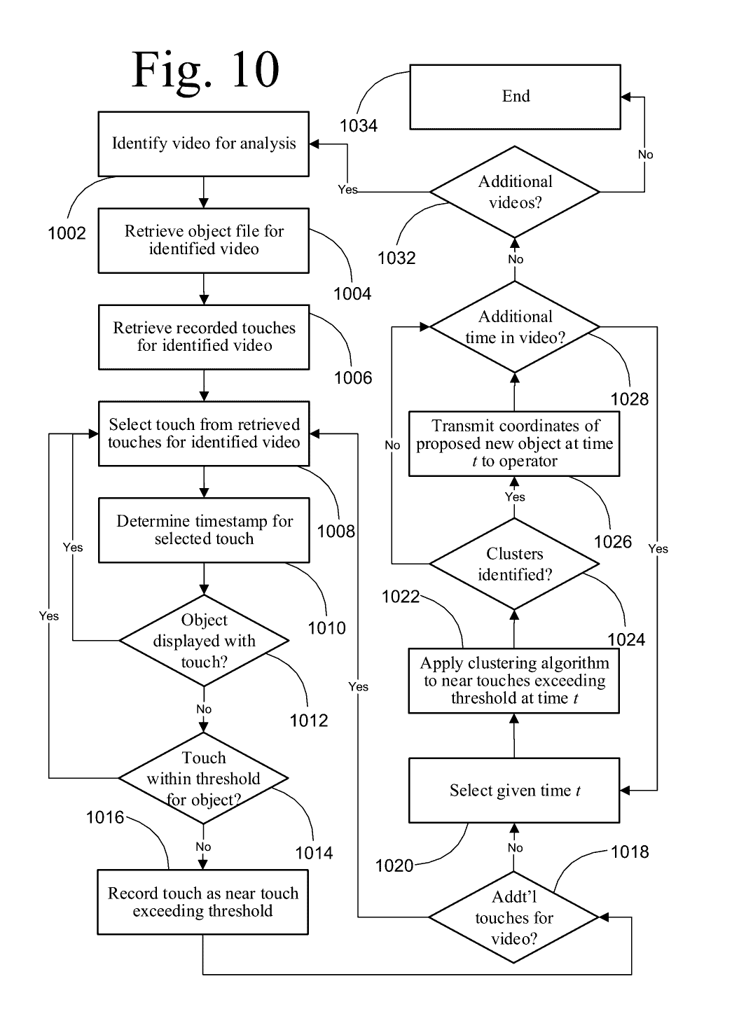

In addition to expanding spatial and temporal thresholds that define a given object appearing in a video, embodiments of the invention comprise processes for adding new objects to a video, e.g., adding an object where there are a number of touches at a given time. FIG. 10 presents a flow diagram illustrating program code instructing a processor to execute a method for identifying and adding a new object to a video stream according to one embodiment of the present invention. The embodiment that FIG. 10 illustrates is an off-line process that begins with the identification of a video for analysis, step 1002. For the video under analysis, the system retrieves an object file or set of objects for the video that identifies the objects appearing in the video, step 1004, and retrieves the historical touches that users have generated while rendering the video on client devices, step 1006. The system may retrieve the object file or set of objects from an object data store and the recorded touches from a touch data store.

Once the system identifies the video, object and touches, processing of the recorded touches commences to identify touches in which a user intended to touch an object, but an object did not exist at the time or coordinates that the user selects. The processing iteratively moves through touches that the system identifies, with the selection of information for a touch from the retrieved touches for the identified video, step 1008. The system determines or otherwise identifies a timestamp for the touch, step 1010, which may indicate the point at which the touch occurred as an offset from the start of the video.

The system performs a check to determine if the video was displaying an object in conjunction with the touch, step 1012. Where the client device identified an object corresponding to an item in the video scene the video player was rendering when the user issued the touch, program flow returns to step 808 with the selection of information for a subsequent touch. Where the check at step 1012 evaluates to false, the system performs a subsequent check to determine if the touch was within a threshold for the object, step 1014, e.g., do the touch coordinates or time fall within the scope of the thresholds for the object coordinates or time at the time of the touch.

Where the touch falls within the threshold for the object, program flow returns to step 1008 with the selection of information for a subsequent touch. Where the touch falls outside the threshold, meaning that the user intended to indicate a touch on a portion of the video scene that does not represent an object (as defined by the object file or data for a given video), the system records the touch as a near touch, step 1016. Upon processing of the information for the touch, the system performs a final check in the sub-process in which it makes a determination whether there are additional touches for the video that require processing, step 1018. Where there are additional touches that require processing, program flow returns to step 1008 with the selection of information for a subsequent touch.

The system concludes initial processing of information for touches in a given video, steps 1008, 1010, 1012, 1014, 1016 and 1018, and begins new object analysis to determine if the near touches require instantiation or the definition of a new object for the video. The system selects a given time, t, at which video player at the client device renders video, step 1020. The system then applies a clustering algorithm to near touches exceeding spatial or temporal thresholds for the object at time t, step 1022, and a check is performed to determine if the clustering algorithm identifies any near misses as a cluster of touches, step 1024. Exemplary clustering algorithms include, but are not limited to, connectivity models, distribution models, density models, subspace models, group models, etc.

Where the system identifies a cluster of near touches, e.g., a plurality of users generating touches at time t where no object exists, the system transmits coordinates for a proposed new object at time t to an operator to consider defining a new object. Regardless of whether or not the system identifies clusters of near touches, the system performs a check to determine if there is additional time in the video, e.g., additional touches at subsequent times that require processing, step 1028. Where analysis of the video is complete, step 1028, the system performs a check to determine if there are additional videos that require analysis, step 1032, directing the system to either identify a next video for analysis, step 1002, or conclude processing, step 1034.

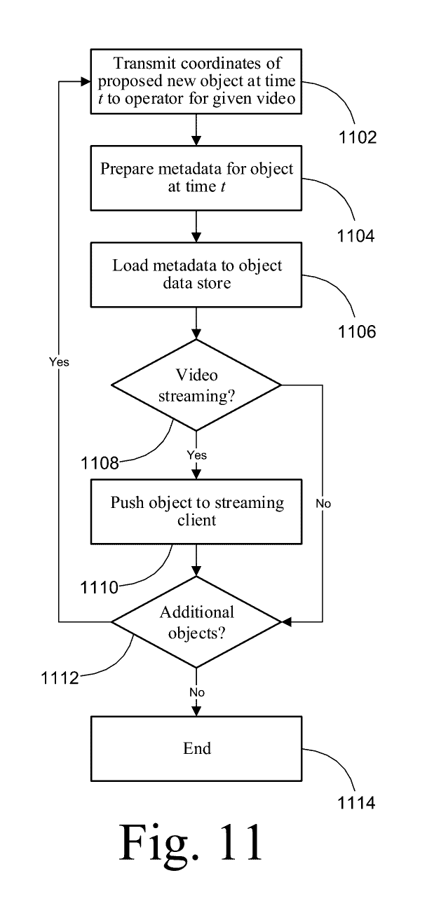

In addition to identifying potential new objects in a video stream, embodiments of the invention comprise hardware and software for defining new objects in the video stream, which may comprise defining new objects after initiation of the video stream. FIG. 11 presents a flow diagram illustrating program code instructing a processor to execute a method for adding new objects to a video stream that is in the process of streaming to a client for playback according to one embodiment of the present invention. The method of FIG. 11 begins with the transmission of coordinates of a proposed new object at time t for a given video to an operator or administrative process, step 1102. The receiving process parses the information for storage as metadata that defines the new object, step 1104, which the process loads into an object data store, step 1106. The process may further comprise supplementing such information with additional information that is descriptive of the new object for use by processes that consume or other act upon the user selection of objects in a video stream. For example, where the object is a handbag, additional information may include, but is not limited to, descriptive information, manufacturer or designer information, price, retail locations for purchase, etc.

A server that is hosting the video data and corresponding object data for the given video stream performs a check to determine if the given video is streaming to one or more clients, step 1108. Embodiments of the invention comprise architectures in which there are multiple, geographically distributed servers for the streaming of video data. In such embodiments, supervisory hardware and software processes, which can make use of an index of addresses from which a given video may be streamed, identify those servers that are hosting the video and instruct said servers to perform the check, step 1108.

Where the video is streaming to one or more clients, the server pushes information regarding the new object to those client devices streaming the video, step 1110. Where the given video is not streaming to any client devices, step 1108, or after pushing information regarding the new object to those clients receiving the video stream, step 1110, the receiving process performs a check to determine if there are additional proposed new objects for the given video, step 1112. Where there are additional proposed new objects for the given video, program flow returns to step 1102 with the transmission of coordinates of another proposed new object at time t (or some other time) for a given video to the operator or administrative process. Where there are no additional proposed new objects for the given video, processing concludes, step 1114.

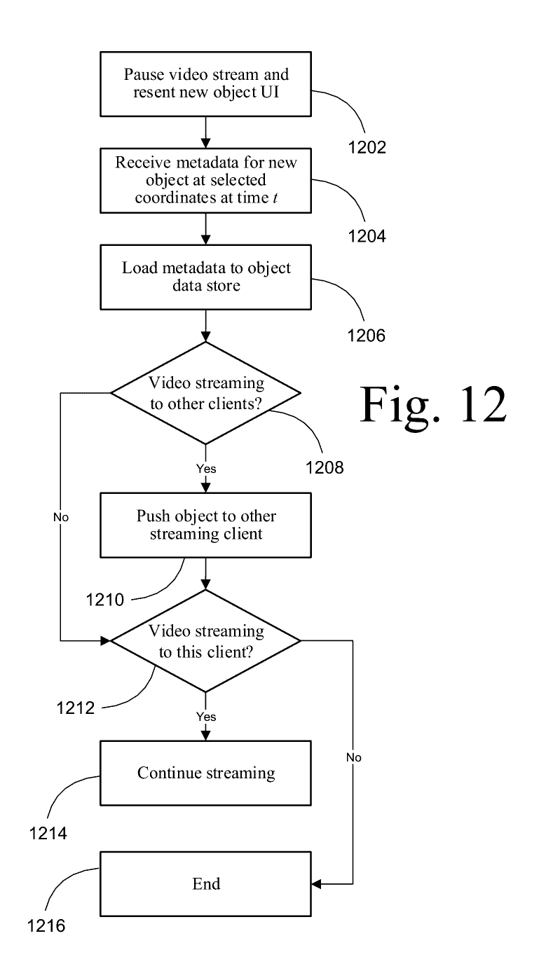

Taking a slightly different approach, FIG. 12 presents a flow diagram illustrating program code instructing a processor to execute a method for dynamically updating objects in a video that is streaming to one or more clients for playback according to one embodiment of the present invention. According to the embodiment of FIG. 12, when a user, who may be an operator or system administrator, wishes to define a new object in a given video, the video stream in paused and the system presents a new object user interface, step 1202. According to various embodiments of the invention, program code executing on processors at the client or server may comprise instructions that control the presentation of the user interface.

A receiving process at the server receives metadata that the user provides regarding the new object, step 1204, such as coordinates for the new object and a time in the video at which the new object is presented, which may also include a time window over which the new object is presented, as well as other information regarding the object. The server loads the metadata into an object data store and performs a check to determine if the video is streaming to other client devices, step 1208. Evaluating to true causes execution of program code by the processor at the server to push information regarding the object to such other client devices, step 1210. Information regarding the new object can be pushed over existing communication channels or sessions between the server and client devices and use analogous protocols, such as HTTP.

The server also performs a check to determine is the video is still streaming to the user who created the new object, step 1212, e.g., that the user has not terminated further transmission of the video stream by closing the video player. In addition, the process of FIG. 12 comprises program code that instructs the processor at the server to push or otherwise save the object information on the client device for the user defining the new object. Where the video is still streaming to the user, the video player at the client device resumes playback of the video stream, step 1214. If not, processing concludes, step 1216.

FIGS. 1 through 12 are conceptual illustrations allowing for an explanation of the present invention. Those of skill in the art should understand that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine-readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for tracking and reacting to touch events that a user generates when viewing a video, the method comprising:
receiving the video at a video player on a client device, the video player under the control of a processor at a client device;
processing object data by the processor at the client device to identify the presence and placement of one or more objects that corresponds to items in the video;
rendering video at the client device by the video player under control of the processor;
receiving touch coordinates and a time that correspond to a touch made by the user on an object that corresponds to an item in the video;
cross-referencing the touch coordinates with the object data; and
recording a touch on the object where the touch coordinates and the time are successfully cross-referenced with the object data.

2. The method of claim 1 comprising rendering a visual indication into the video when recording a touch, the visual indication displayed in conjunction with the item in the video.

3. The method of claim 2 wherein rendering the visual indication comprises displaying an icon in conjunction with the item as the item moves in the video as a function of time.

4. The method of claim 1 wherein processing the object data comprises identifying one or more data items, a given data item related to an object that corresponds to an item in the video.

5. The method of claim 1 wherein processing the object data comprises identifying an x-y coordinate for a given object at a given time.

6. The method of claim 5 wherein processing the object data comprises identifying a plurality of x-y coordinates for the given object at a plurality of corresponding times.

7. The method of claim 5 comprising synchronizing the plurality of times with the presence and placement of items in the video.

8. Non-transitory computer readable media comprising program code that when executed by a programmable processor causes execution of a method for tracking and reacting to touch events that a user generates when viewing a video, the program code comprising:
program code for receiving the video at a video player on a client device, the video player under the control of the processor at a client device;
program code for processing object data by the processor at the client device to identify the presence and placement of one or more objects that corresponds to items in the video;
program code for rendering video at the client device;
program code for receiving touch coordinates and a time that correspond to a touch made by the user on an object that corresponds to an item in the video;
program code for cross-referencing the touch coordinates with the object data; and
program code for recording a touch on the object where the touch coordinates and the time are successfully cross-referenced with the object data.

9. The program code of claim 8 comprising program code for rendering a visual indication into the video when recording a touch, the visual indication displayed in conjunction with the item in the video.

10. The program code of claim 9 wherein the program code for rendering the visual indication comprises program code for displaying an icon in conjunction with the item as the item moves in the video as a function of time.

11. The program code of claim 8 wherein the program code for processing the object data comprises program code for identifying one or more data items, a given data item related to an object that corresponds to an item in the video.

12. The program code of claim 8 wherein the program code for processing the object data comprises program code for identifying an x-y coordinate for a given object at a given time.

13. The program code of claim 12 wherein the program code for processing the object data comprises program code for identifying a plurality of x-y coordinates for the given object at a plurality of corresponding times.

14. The program code of claim 12 comprising program code for synchronizing the plurality of times with the presence and placement of items in the video.

15. A system for tracking and reacting to touch events that a user generates when viewing a video, the system comprising:
a video player executing on a client device under the control of a processor to render a video scene on the client device to the user;
an object data store to maintain information regarding the presence and placement of one or more objects that corresponds to items in the video;
a touch engine operative to receive touch coordinates and a time that correspond to a touch made by the user on an object that corresponds to an item in the video, cross-reference the touch coordinates with the information from the object data store and record a touch on an object where the touch coordinates and the time are successfully cross-referenced with the information from the object data store; and
a touch data store to maintain a record of a successful cross reference by the touch engine.

16. The system of claim 15 wherein the object data store comprises one or more data items, a given data item related to an object that corresponds to an item in the video.

17. The system of claim 15 wherein a given data item comprises an x-y coordinate for a given object at a given time.

18. The system of claim 17 wherein a given data item comprises a plurality of x-y coordinates for the given object at a plurality of corresponding times.

19. The system of claim 15 comprising a visual indication rendered into the video when recording a touch, the visual indication displayed in conjunction with the item in the video.

20. The system of claim 19 wherein the visual indication comprises display of an icon in conjunction with the item as the item moves in the video as a function of time.
